(19) United States
(12) Patent Application Publication
(10) Pub. No.: US 2010/0323175 A1
(43) Pub. Date: Dec. 23, 2010

(54) Paper Board and Making Method Thereof

(76) Inventor: Jian TAO, Shen Zhen City (CN)

Correspondence Address: Jackson Intellectual Property Group PLLC, 106 Starvale Lane, Shipman, VA, 22971, US

(21) Appl. No.: 12/487,720

(22) Filed: Jun. 19, 2009

(51) Int. Cl. B32B 15/12; B32B 3/10; B32B 29/00; B32B 37/00

(52) U.S. Cl. 428/209; 428/457; 156/324; 156/277; 156/280

(57) ABSTRACT

The present invention relates to a paper board and making method thereof. The paper board comprises a kraft paper, a glue layer located on the kraft paper, and an aluminium plating film located on the glue layer. The method of making a paper board comprises: step 1, providing a kraft paper; step 2, providing an aluminium plating film; step 3, compounding the aluminium plating film to the kraft paper via glue. In step 3, the aluminium plating film is closely attached to the kraft paper with glue through pressing, so as to form a composite paper board. The method of making the paper board of the present invention is simple and reduces the cost. The paper board has a reliable quality, a long endurance, a beautiful appearance, and a low cost.

### FIELD OF THE INVENTION

The present invention relates to a paper board and making method thereof, particularly relates to a paper board made of kraft paper and aluminium plating film, and a method of making the paper board.

### BACKGROUND OF THE INVENTION

Currently, paper packing bags are used more and more widely. For example, paper packing bags are often used in trades of food, cosmetic, stationery, clothes, decoration, and so on. The applying of paper packing bags brings great convenience to people's life.

Conventional paper boards adopted to make the packing bags can be classified as noncolor printing and color printing. As to the former, yellow kraft paper is basically used as the plane material, and then is compounded to ordinary box paper boards via a compound machine to form noncolor printing paper boards. This kind of noncolor printing paper boards has neither beautiful appearance nor reliable quality, and is easily broken. As to the latter, comparatively expensive wood pulp type of white board, ivory board, or copper plate paper is adopted to implement sheet-fed color planographic printing, then is laminated with an ordinary single-piece paper board that employs yellow kraft paper as the plane material, and finally is coated with a protecting film on the pattern layer of the paper board to increase the wear resistance ability. This kind of color printing paper board not only has a comparatively high cost, but also has a comparatively complicated manufacture technology, which results in high price of the finished packing bags.

### SUMMARY OF THE INVENTION

An object of the present invention is to provide a paper board which has characteristics of beautiful appearance and good wear resistance with low cost.

Another object of the present invention is to provide a method of making a paper board, which can reduce the production cost and simplify the production flow.

To achieve the above mentioned objects, a paper board of the present invention comprises a kraft paper, a glue layer located on the kraft paper and an aluminium plating film located on the glue layer.

The paper board further comprises a first pattern layer located on the aluminium plating film.

The paper board further comprises a second pattern layer located at the other side of the kraft paper opposite to the aluminium plating film.

Wherein the first pattern layer is a pattern layer with a single color, or is a pattern layer with patterns or figures.

Wherein the second pattern layer is a pattern layer with a single color, or is a pattern layer with patterns or figures.

A method of making a paper board of the present invention comprises the following steps:

step 1, providing a kraft paper;

step 2, providing an aluminium plating film; and

step 3, compounding the aluminium plating film to the kraft paper via glue, in step 3, the aluminium plating film being closely attached to the kraft paper with glue through pressing, so as to form a composite paper board.

The method of making a paper board further comprises step 4, providing a first pattern layer on the aluminium plating film.

Wherein in step 4, the first pattern layer is provided on the aluminium plating film by printing.

The method of making a paper board further comprises step 5, providing a second pattern layer at the other side of the kraft paper opposite to the aluminium plating film.

Wherein in step 5, the second pattern layer is provided to the kraft paper by dyeing.

The method of making a paper board of the present invention is simple and reduces the cost. The paper board has a reliable quality, a long endurance, a beautiful appearance, and a low cost.

The characteristic and the technical solution of the present invention are best understood from the following detailed description with reference to the accompanying figures, but the figures are only for reference and explaining, not to limit the scope of the invention.

### BRIEF DESCRIPTION OF THE DRAWINGS

The technical solution and the beneficial effects of the present invention are best understood from the following detailed description with reference to the accompanying figures and embodiments.

FIG. 1 is a cross sectional view of a paper board of the present invention;

FIG. 2 is a flow chart of a method of making a paper board of the present invention.

### DESCRIPTION OF THE PREFERRED EMBODIMENT

To further set forth the technical solution adopted by the present invention to achieve the predetermined objects and the effects, please read the following detailed description and figures according to the present invention; the objects, characteristics and novel features of the present invention will be best understood, but the figures are only for reference and explaining, not to limit the scope of the invention,

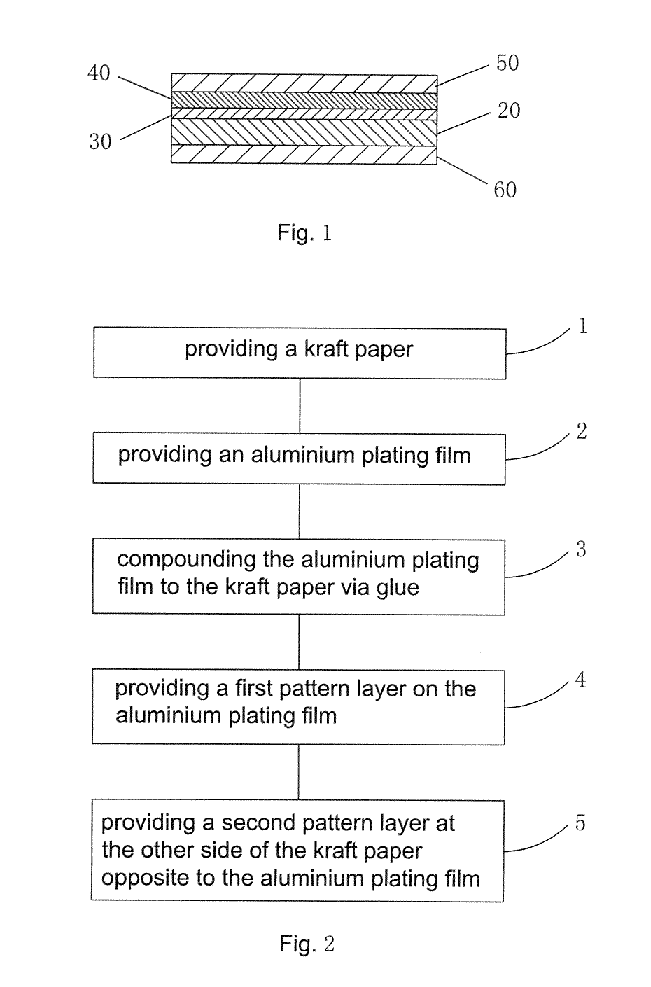

As shown in FIG. 1, a paper board of the present invention comprises a kraft paper 20, a glue layer 30 located on the kraft paper 20, and an aluminium plating film 40 located on the glue layer 30. The aluminium plating film 40 has the effect of lamination, and so does not need an extra lamination. Since conventional packing bags having the same paper characteristics need an extra lamination to protect the paper board, the use of aluminium plating film 40 can simplify process and save materials, thereby reducing cost.

The paper board of the present invention further comprises a first pattern layer 50 located on the aluminium plating film 40. The first pattern layer 50 can be disposed on the aluminium plating film 40 via printing. The first pattern layer 50 can be a pattern layer with a single color, and can also be a pattern layer with patterns or figures.

The paper board of the present invention further comprises a second pattern layer 60 located at the other side of the kraft paper 20 opposite to the aluminium plating film 40. The second pattern layer 60 can be provided to the kraft paper 20 via dyeing. The second pattern layer 60 can be a pattern layer with a single color, and can also be a pattern layer with patterns or figures.

In the present invention, the aluminium plating film 40 is compounded to the kraft paper 20 via the glue layer 30, and the first and the second pattern layers 50, 60 are provided to get better decorative effect, so as to form a new paper board which has a good texture, a long endurance, and a low cost. Comparing with the conventional paper boards of the same quality, such as the copper plate paper, the paper board of the present invention can reduce the cost by thirty percent, which is a huge improvement to the materials of the conventional paper packing bags, and gets a great success in the commerce.

As shown in FIG. 2, a method of making a paper board of the present invention comprises the following steps.

Step 1, providing a kraft paper, which is a kind of the cheapest papers in the conventional paper products, and has a great flexibility.

Step 2, providing an aluminium plating film.

Step 3, compounding the aluminium plating film to the kraft paper via glue. The aluminium plating film is closely attached to the kraft paper with glue through pressing, so as to form a composite paper board. The composite paper board has more flexibility than the original substrate of kraft paper materials, and so can load heavier goods.

Step 4, providing a first pattern layer on the surface of the aluminium plating film. The first pattern layer is provided on the aluminium plating film by printing. Since the aluminium plating film has the effect of lamination, patterns can be directly provided on the aluminium plating film without an extra gluing layer, which not only simplifies the production flow, but also reduces the production cost at a certain extent. The first pattern layer not only increases the aesthetic sensibility of the appearance of the paper board, but also has a certain protective action to the surface of the paper board, so as to increase the wear resistance ability of the paper board.

Step 5, providing a second pattern layer at the other side of the kraft paper opposite to the aluminium plating film. The second pattern layer is provided by dyeing, and the second pattern layer can increase the aesthetic sensibility of the inner side of the paper board.

In summary, the method of making the paper board of the present invention is simple and reduces the cost. The paper board has a reliable quality, a long endurance, a beautiful appearance, and a low cost.

Although the present invention has been described in detail with above said embodiments, but it is not to limit the scope of the invention. So, all the modifications and changes according to the characteristic and spirit of the present invention, are involved in the protected scope of the invention.

1. A paper board comprising a kraft paper, a glue layer located on the kraft paper, and an aluminium plating film located on the glue layer, wherein the aluminum plating film is configured to protect the paper board without applying a separate lamination layer.

2. The paper board of claim 1, further comprising a first pattern layer located on the aluminium plating film.

3. The paper board of claim 1, further comprising a second pattern layer located at the other side of the kraft paper opposite to the aluminium plating film.

4. The paper board of claim 2, wherein the first pattern layer is a pattern layer with a single color, or is a pattern layer with patterns or figures.

5. The paper board of claim 3, wherein the second pattern layer is a pattern layer with a single color, or is a pattern layer with patterns or figures.

6. A method of making a paper board comprising the following steps:
step 1, providing a kraft paper;
step 2, providing an aluminium plating film configured to protect the paper board without applying a separate lamination layer; and
step 3, compounding the aluminium plating film to the kraft paper via glue, in step 3, the aluminium plating film being closely attached to the kraft paper with glue through pressing, so as to form a composite paper board.

7. The method of making a paper board of claim 6, further comprising step 4, providing a first pattern layer on the aluminium plating film.

8. The method of making a paper board of claim 7, wherein in step 4, the first pattern layer is provided on the aluminum plating film by printing.

9. The method of making a paper board of claim 6, further comprising step 5, providing a second pattern layer at the other side of the kraft paper opposite to the aluminium plating film.

10. The method of making a paper board of claim 9, wherein in step 5, he second pattern layer is provided to the kraft paper by dyeing.
